(19) United States
(12) Patent Application Publication
(10) Pub. No.: US 2007/0211482 A1
(43) Pub. Date: Sep. 13, 2007

(54) METHOD FOR CONTROLLING THE AUTOMATIC SWITCHING OF THE PROJECTOR OF A VEHICLE

(75) Inventor: Julien Rebut, Paris (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 11/683,560

(22) Filed: Mar. 8, 2007

(30) Foreign Application Priority Data
Mar. 10, 2006 (FR) 0602156

(51) Int. Cl. B60Q 1/00

(52) U.S. Cl. 362/466

(57) ABSTRACT

The invention relates to a method for controlling the automatic switching of the projector of a vehicle, in particular of a motor vehicle, from a first lighting mode to a second lighting mode, the method being implemented when the vehicle is driven at night and including the following steps: acquisition by a black and white sensor of images representing night-time road scenes, extraction from the images of the zones corresponding to light sources, and discrimination of the type of light sources in accordance with the distribution of the levels of light intensity in the zones.

### BACKGROUND OF THE INVENTION

1. Field of the Invention

The invention relates generally to the field of lighting for motor vehicles. More specifically, the invention is concerned with projector control modes allowing projectors to be made to pass automatically from one operating mode to another. This may, for example, involve the automatic switching of the projectors of a vehicle from a “high beam”-type lighting state to a “low beam/dipped” lighting state when a situation is detected that is liable to dazzle the driver driving in the opposing direction or the driver of the preceding vehicle on the road in the same direction (dazzling via the rear-view mirrors). However, other types of switching are also conceivable, for example for passing from an “off” mode to a “dipped or high beam” mode.

2. Description of the Related Art

The literature has already proposed on-board devices allowing dipped/high beam projector switching, devices using various types of sensors/cameras and modes for processing the collected images.

These devices are complex, and it is very important that they are reliable and robust, as safety is at stake. They must, in particular, be able to interpret correctly the nature of the light sources detected by the sensors. However, it is difficult to be sure that light sources present in the landscape originate from passing vehicle projectors or from signal lights from vehicles located on the same lane and that they are not merely reflections of the light from the projectors of the driver's own vehicle or other vehicles on road signs. In the event of confusion, there is a risk that the projectors will be switched in a badly timed manner from the high beam mode to the dipped mode, and this will unnecessarily restrict the view of the driver of the vehicle. There is also a risk of switching the projector from the high beam mode or dipped mode too late, owing to a detection error, and this will dazzle the driver of the passing vehicle.

Strategies based on trajectory analysis allow identification with an acceptable level of confidence of parasitic light sources such as urban lighting and, to a lesser degree, the vehicles passing the vehicle in question, but such strategies can prove ambiguous.

More specifically, this is the case when the light sources are remote from the vehicle in question (several hundreds of meters) and also for sources therefore having slight displacement within the image detected by the sensors. However, it is at between 600 and 1,000 meters that it is necessary to switch the projector from a high beam mode to a dipped mode in order to avoid dazzling the driver driving in the opposing direction and to ensure that the automatic high beam/dipped shift takes place in a similar manner to a manual shift. And, with the preceding vehicle, it is at beyond approximately 400 meters that the projector can again be switched from a dipped mode to a high beam mode.

A first solution consists in using sensors capable of detecting the color of the detected lights. It is thus possible to distinguish between the light emitted by rear lights, light emitted by projectors or light which is merely the reflection of light on road signs. Although the spectral information is useful, this method requires color sensors which are not without drawbacks. They are, in particular, equipped with filters which are liable to age prematurely. They are also less sensitive to grey levels then black and white sensors, and this is also detrimental if these sensors are intended to be used to perform a plurality of functions, in particular for not only a dipped/high beam switching function but also a night vision function and/or an LDWS (lane departure warning signal) function.

The object of the invention is therefore to remedy these drawbacks. The invention aims, in particular, to increase the reliability of projector automatic control systems, further to reduce detection errors between “true” light sources, requiring the initiation of an automatic modification of the projector lighting mode, and parasitic light sources to be ignored. In addition, the invention seeks to achieve these objects without using color sensors

What is needed, therefore, is an automatic light system that improves over the methods and systems of the past

### SUMMARY OF THE INVENTION

The invention relates to a method for controlling the automatic switching of the projector of a vehicle, in particular of a motor vehicle, from a first lighting mode to a second lighting mode, the method being implemented when the vehicle is driven at night and including the following steps:

a—acquisition by a black and white sensor of images representing night-time road scenes,

b—extraction from the images of the zones corresponding to light sources,

c—discrimination of the type of light sources in accordance with the distribution of the levels of light intensity in the zones.

In this current application, the term “extraction” is to be understood as the current meaning usually used in the field of image processing, namely the identification of an area (or zone) of an image. An area of an image is identified or extracted by the determination of its localization in the image and its boundaries with the rest of the image. For example, the extraction of objects of an image corresponding to defined characteristics corresponds to the identification in the image of the area corresponding to the objects which will have the defined characteristics, this area being identified by its position (or coordinates) in the image and by its boundaries within the image.

According to the invention, use is therefore made of a black and white sensor: instead of identifying the detected light sources by the colors thereof, they are identified in this case by the variations in the light intensity of the detected zones corresponding to these light sources. It has been found that certain light sources had sufficiently characteristic intensity distributions to allow them to be discerned using a black and white sensor. It should briefly be noted that black and white sensors have advantages over color sensors, in particular because they can also be used for other functions in the vehicle such as night (infrared) vision, and this is not the case with color sensors. The appropriate black and white sensor must be chosen, having, in particular, sufficient sensitivity and dynamics to detect all the necessary grey levels.

Advantageously, step c— involving the discrimination of the type of light sources includes a zone-thresholding sub-step c0 allowing identification of the type A light sources saturating the sensor with light intensity, including the passing vehicle projector lights.

The inventors started from the observation that the projector lights had very high intensity compared to other light sources which can be encountered on the road, such as signal lights: by appropriately adjusting the sensitivity of the sensor, so that it saturates when it “sees” a projector at the conventional distance at which a driver would manually switch his projectors from high beam mode to dipped mode, it can easily be identified that a light source is of the passing projector type, so the projector can subsequently and after validation (by checking it, for example, on a plurality of successively acquired images) be switched automatically from “high beam” to “dipped”.

Also advantageously, the discrimination step c— includes:

C1—determining the levels of light intensity in the non-thresholded zones/zones not saturating the sensor,

C2—measuring the similarity between the light intensity distribution of each non-thresholded thresholded zone and a Gaussian-type modeled distribution, and

C3—a model search for the lights emitted by the vehicles far behind: the “signatures” of the lights representing the distribution of light intensity levels are characteristic (with two “bumps”) and allow them to be discerned by searching these shapes.

Preferably, steps C0, C1 and C3 are carried out simultaneously: a thresholded zone according to C0 or according to C3, for example, is not processed in accordance with C1/C2.

It was found within the scope of the invention that there was a genuine risk of confusion between two types of sources: sources corresponding to signal lights from the vehicle preceding the vehicle equipped with the automatic switching device and sources which are merely secondary sources corresponding to road signs reflecting the light originating, for example, from the projectors of the vehicle equipped with the device itself. However, the system has to be able to differentiate these and to ignore the secondary sources (by leaving the projectors in high beam mode) and to take account of the signal lights-type sources (by causing the projectors to be switched from a high beam mode to a dipped mode).

In order to do this, and without color information, as the sensor used is a black and white sensor, it was found that the signal lights left on the image acquired by the sensor a zone of light intensity varying from one point in the zone to another. The three-dimensional representation of the light intensity (at z) of a light point/of a pixel of the zone as a function of the location of this pixel in the zone in question (at x, y) closely approximates a three-dimensional Gaussian distribution. On the other hand, the representation corresponding to a secondary light source is remote from a Gaussian form and has, in particular, local variations in intensity corresponding to details not encountered with signal lights.

The invention therefore benefits from these differences by comparing the light intensity distribution thereof depending on whether it approximates a Gaussian form (signal lights, having a high level of similarity to a Gaussian form) or does not (secondary sources to be ignored, having a low level of similarity to a Gaussian form). The level of similarity can easily be calculated, using calculators/computer means on board the vehicle, from actually measured distributions, in particular by approximation.

This is effective and has proven to be highly reliable. This practice can be extrapolated to other types of light sources provided that they have characteristic and repetitive representations of the variation in light intensity. In this case, the step C2, corresponds to measuring the similarity between the light intensity distribution of each non-thresholded zone and a modeled distribution of this type of light sources.

The discrimination step c— thus sorts the light zones depending on whether they are above or below a given level of similarity, the zones above the level corresponding to type B light sources including rear vehicle lights, the zones below the level corresponding to type C secondary light sources such as reflective road signs.

The method according to one of the preceding claims advantageously includes the step of:

e—controlling the switching of the projector from one lighting mode to another lighting mode taking account of the results of the discrimination step c—, in particular controlling switching from a high beam-type lighting mode to a dipped-type lighting mode in the event of the identification of type A or type B light sources, or remaining in high beam mode in the event of the identification of type C light sources.

To increase the reliability of the discrimination by type of light sources, it is preferable that the acquisition a—, extraction b— and discrimination c— steps at least are repeated a plurality of times, and the results thereof compared before initiating, in the event of sufficient coincidence, switching-controlling step e—.

Advantageously, the method according to the invention also includes a step g/h—for monitoring with respect to time in order to identify the trajectories of the zones corresponding to light sources. This step, by monitoring the trajectory of a source in a sequence of images, allows the behavior of this trajectory to be compared with typical behaviors, such as a vehicle overtaking-type trajectory, of the type of the trajectory of a vehicle passing in the lane in the opposing direction, and the identification of the light sources to be made even more reliable.

In parallel with the trajectory identification step, there can also be provided a delay means for increasing the reliability of the differentiation between motorcycle lights or projectors and road signs: if the zone corresponding to a light source remains within the image, does not “leave the scene” within a given period of time, it is confirmed that it is indeed a motorcycle light and not a road sign. This waiting time for checking the displacement or non-displacement of the zone within the image can be associated with the identification of trajectories: provided that a specific trajectory has not been determined, the control of the projectors can be delayed and if, at the end of a given time, the speed of the vehicle being known, the source remains within the image, the high beam/dipped switching can be commanded.

Advantageously, the method also includes a step i— after the image acquisition step a—, the step i— seeking to eliminate from the images the zones corresponding to secondary light sources of predetermined geometric shapes. Preferably, step i— includes extraction of the contours of the zone corresponding to a light source within the image, extraction of the linear, in particular horizontal and vertical, segments of the zone, construction of geometrical objects from these segments, then elimination of the objects corresponding to predetermined geometric shapes, in particular rectangular shapes representing the reflective zones of signposts.

It was found that in addition to the road signs, there was another type of secondary light source which it is useful to identify so that the control system can ignore them: these are the reflective zones, of simple geometric shapes such as a square or a rectangle, which are present on posts bordering roads, especially for signalling bends. These zones, which are usually white, have been specially developed to reflect strongly the light from projectors: they therefore tend to saturate the sensor. The invention therefore proposes to identify, during this prior step, whether the images contain a secondary source of this type and, if they do, to eliminate the corresponding zones from the images before carrying out the thresholding and discrimination described hereinbefore.

Preferably, the method according to the invention includes a step j— for detecting the lane edges LDWS. This information is then used to update the position of the horizon (the escape lines corresponding to the detected edges are defined, the intersection of the escape lines allowing the horizon to be located).

Preferably, the method according to the invention includes a step h— for estimating the location of the horizon within the images acquired in step a—. As was stated hereinbefore, this location can be estimated by exploiting the results of edge detection step j—. This also allows increased reliability of the identification of the detected light sources: a decision can be taken to ignore them if this step establishes that they are located well above the estimated horizon line. This can also be a means for confirming the detection of a motorcycle light or projector. It can be confirmed that the light source is of the vehicle light or projector type by detecting two similar zones coupled within the image. A single zone, on the other hand, can correspond either to a secondary source to be ignored or to a vehicle light or projector, the second light/the second projector of which is damaged, or to a motorcycle light or projector. When a single source is detected and, moreover, is on the horizon, the information is confirmed that it is indeed a vehicle light/a projector and not a secondary source, the presence of a motorcycle being highly likely.

The invention also relates to the device allowing the method described hereinbefore to be carried out, with all the means capable of carrying out all the steps of the method.

The invention relates, in particular, to a device for controlling the automatic switching of the projector of a vehicle, in particular of a motor vehicle, from a first lighting mode to a second lighting mode, the device being activated when said vehicle is driven at night, comprising:

a—means for the acquisition of images representing night-time road scenes, comprising a black and white sensor,

b—means for the extraction from the images of the zones corresponding to light sources,

c—means for the discrimination of the type of light sources in accordance with the distribution of the levels of light intensity in the zones.

This device preferably comprises:

f—means for controlling the switching of the projectors from one lighting mode to another, taking account of the results obtained with the discrimination means c—.

Advantageously, the sensor used in the method and the device described hereinbefore can be shared with at least one other device fitted to the vehicle (such as a night vision device displaying, in proximity to the dashboard, information from infrared images).

The invention also relates to any information storage means, storing one or more programs, the execution of which authorizes implementation of the method described hereinbefore.

The invention also relates to any computer program on an information storage means, comprising one or more sequences of instructions which can be executed by a microprocessor and/or a computer, the execution of the sequences of instructions authorizing implementation of the method described hereinbefore.

Further aspects and advantages of the present invention will become apparent on reading the description of a specific non-limiting embodiment given with reference to the appended drawings, in which:.

### DESCRIPTION OF THE PREFERRED EMBODIMENTS

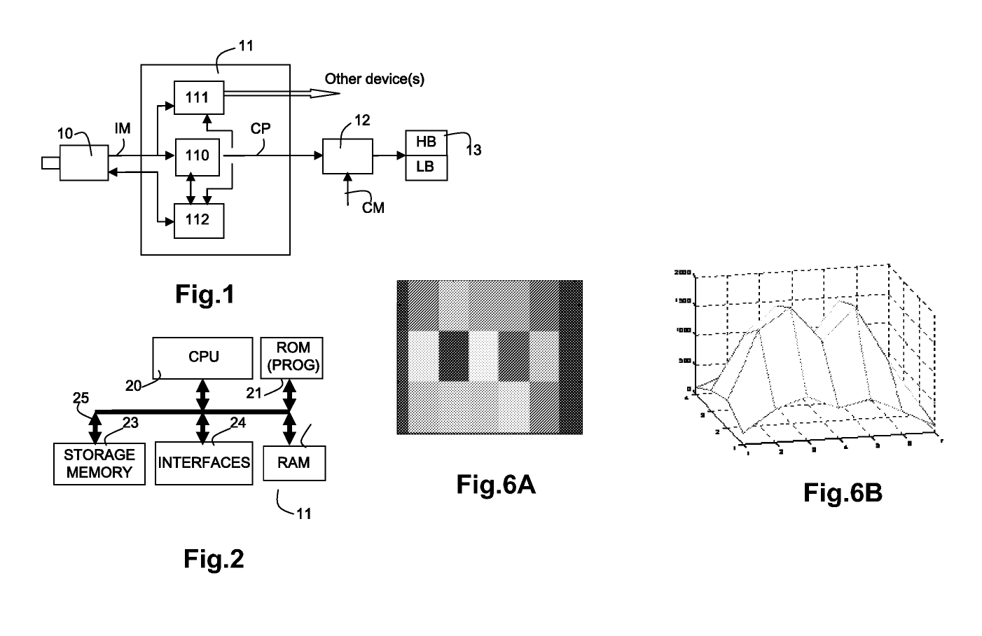

FIG. 1 shows the general structure of an automatic switching control device according to the invention,

FIG. 2 shows a material configuration of a processing unit used by the invention,

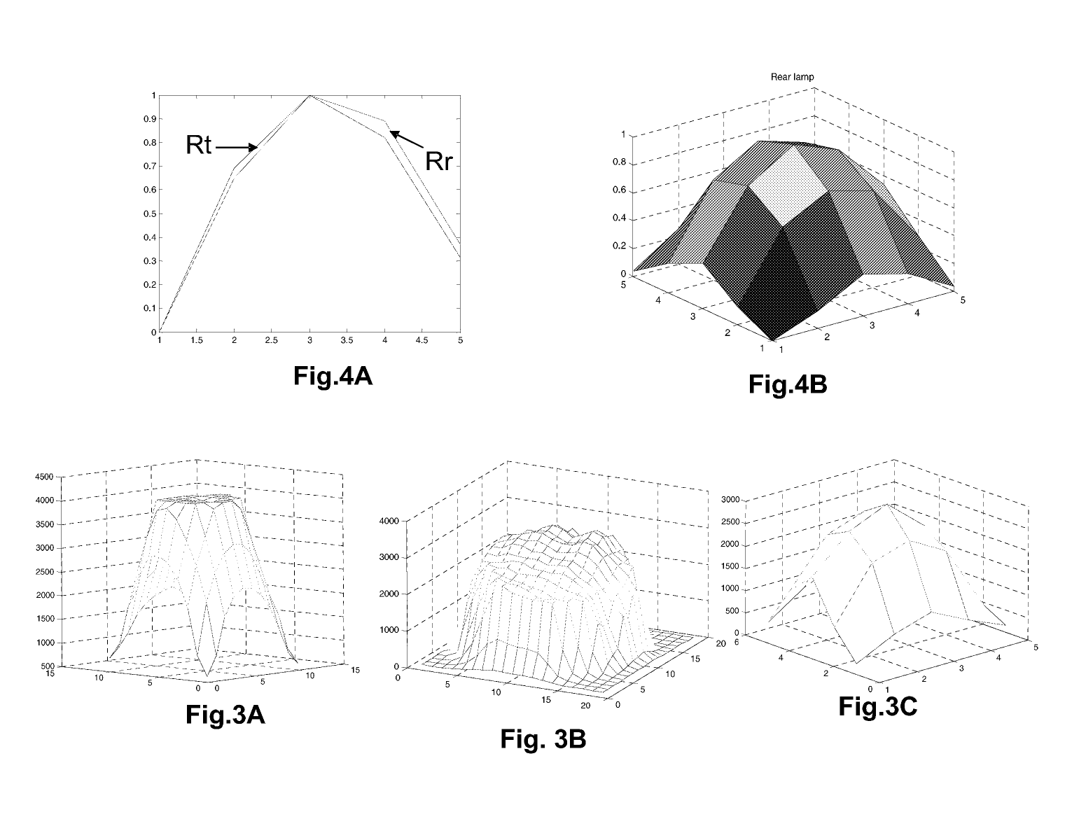

FIGS. 3A, 3B and 3C are three-dimensional representations of the variation in light intensity of three types of light source,

FIGS. 4A and 4B illustrate the processing for discerning between two types of light source,

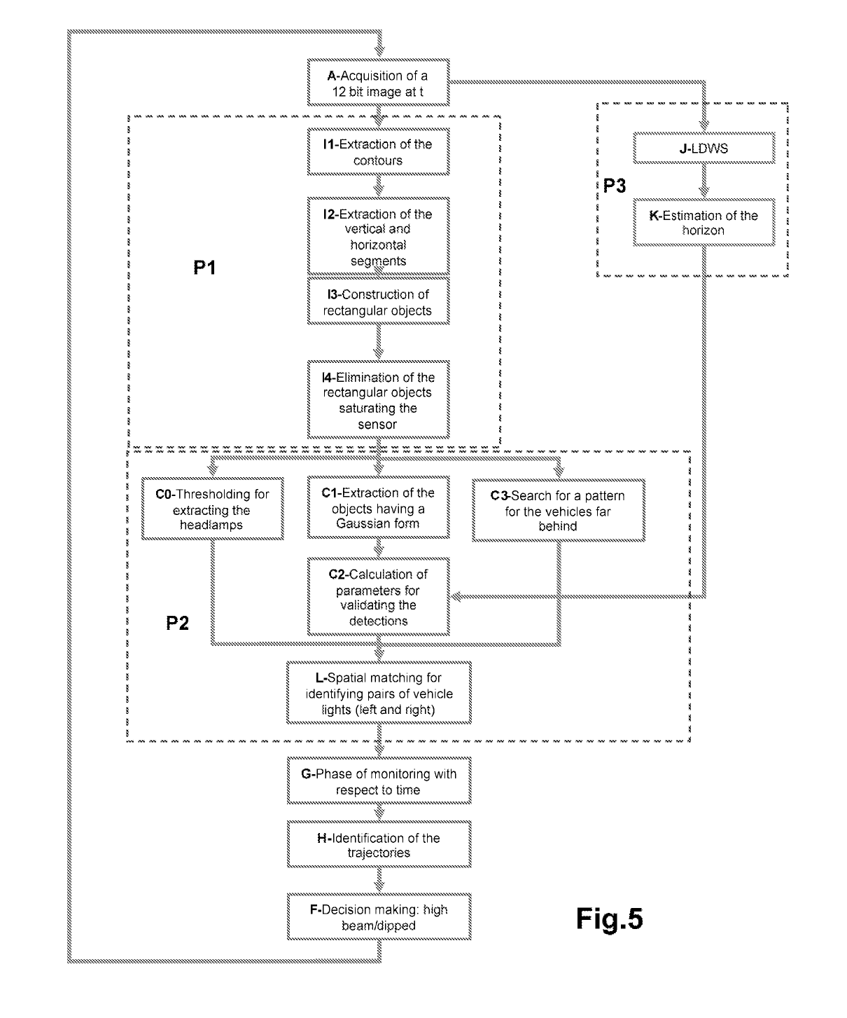

FIG. 5 shows an algorithm for implementation of a method according to the invention, and

FIGS. 6A and 6B are two and three-dimensional representations of the variation in light intensity of another type of light source.

### DESCRIPTION OF THE PREFERRED EMBODIMENTS

The invention will now be described using a non-limiting example of a device for controlling the automatic switching of the lighting projectors of a motor vehicle from a “high beam” lighting mode to a “dipped/low beam” lighting mode. With reference to FIG. 1, the device for controlling the automatic switching of lighting projectors according to the invention controls the switching of the lighting projectors 13 of a vehicle and basically comprises a camera 10, a processing unit 11 and a switching circuit 12.

As is well known, projectors 13 can record various lighting/signalling states such as “daytime running light” (DRL), “parking light”, “low beam light” and “high beam light”. The “low beam light” LB and “high beam light” HB states are illustrated schematically in FIG. 1.

The camera 10 is installed in the vehicle so as to record successive road scenes from the front of the vehicle. The camera 10 delivers images IM to the processing unit 11.

In the embodiments described in the present application, the camera 10 uses a black and white sensor of high dynamics and high sensitivity. (It will be noted that the sensitivity of a sensor corresponds to its capacity to detect slight variations in light intensity and that its dynamics correspond to its capacity to detect over a broad range of light intensities.) This sensor preferably has dynamics of 120 db, with a signal coded over 12 bits, i.e. 4,096 grey levels (the term “grey levels”, as used throughout the present text, refers to the range of the various detectable light intensity levels).

The image IM supplied by the camera 10 is digitized by an analog/digital converter (not shown) implanted in the processing unit 11. In the embodiment illustrated in FIG. 1, the digitized image IM is supplied to software processing modules 110 and 111.

The software processing module 110 is dedicated, in the processing unit 11, to the operation of the device for controlling the automatic switching of lighting projectors according to the invention. In accordance with the invention, the software processing module 110 is capable of processing the image IM1 and of extracting therefrom an item of information CP for controlling the projectors 12. In this embodiment of the invention, the item of information for controlling the projector CP commands the automatic switching of the projectors from the “high beam” state to the “low beam” state.

The element denoted by reference numeral 111 illustrates schematically various other software processing modules which are implanted in the processing unit 11 and fulfill processing functions other than those required by the device for controlling the automatic switching of lighting projectors according to the invention. The software modules 111 pertain to other devices which are on board the vehicle and share the images IM and the processing unit 11 with the device for controlling the automatic switching of lighting projectors according to the invention. These other devices are, for example, an on-road navigation aid and/or a bend detection device for controlling the projectors in bends (bending light).

In addition to the item of control information CP, the switching circuit 12 also receives an item of manual control information CM. The item of manual control information CM represents manual actuation of the lighting combination control means by the driver of the vehicle. This manual actuation CM by the driver maintains priority over the automatic control CP of the projectors.

As shown in FIG. 2, the processing unit 11 has a conventional architecture and comprises a central processing unit CPU 20 such as a microprocessor, a ROM or EEPROM 21, a RAM 22, a storage memory 23, for example of the FLASH type, interfaces 24 and an internal communication bus 25. In another embodiment of the invention, the processing unit 11 is also equipped with a man/machine communication means such as a keypad through which the driver can select various modes of operation.

The processing unit 11 executes one or more programs PROG which authorize implementation of the method according to the invention.

In the configuration of FIG. 2, the executable code of the programs PROG is partially or entirely accommodated in the ROM 21.

The executable code of the programs PROG can also be partially loaded into the storage memory 23, via the interfaces 24, from, for example, a disk introduced into a disk reader or through a communication link connected, for example, to a microcomputer used for configuring the processing unit 11.

Obviously, the disk from which the programs PROG are loaded can be replaced by a CAROM or a memory card. More generally, any means for storing information which can be read by a computer or a microprocessor, which may or may not be integrated into the, optionally detachable, processing unit 11, is adapted to storing, entirely or in part, the programs PROG.

The central unit 20 controls the execution of the instructions or code portions of the programs PROG, the instructions being stored in the ROM 21 and/or the storage memory 23 and/or the other information storage means indicated hereinbefore.

When the processing unit 11 is powered, the programs PROG stored in a non-volatile memory, such as the ROM 21 or the storage memory 23, are transferred entirely or in part to the volatile RAM 22 which will then contain the executable code transferred from the programs PROG, as well as various registers for storing variables and parameters necessary for carrying out the method according to the invention.

It will also be noted that the processing unit 11 can assume the form of a programmed means, this programmed means then containing the executable code of the programs PROG in a form frozen in an application-specific integrated circuit (ASIC).

As described hereinbefore, the switching system has to be capable of differentiating between front projectors, rear lights and “false” light sources which are merely reflections of light, more specifically on road signs.

Using a monochrome sensor, the only item of information available is in the form of the grey levels representing the intensity of the light received by the sensor.

FIG. 3A shows the distribution of the light intensity of a light source corresponding to the light from a projector 100 meters away from the vehicle equipped with the device. Axes x and y show the surface area of the zone of the image acquired by the sensor, axis z shows the light intensity of each pixel of the zone.

This figure shows that the light intensity is very strong relative to other vehicle light-type sources. Care is taken to calibrate the sensor, so the light emitted by a vehicle projector is the only light capable of saturating the sensor. Thus, once a saturation threshold has been crossed, the control system “knows” that it is a projector light without further examining the processing of the zone of the image corresponding to this light.

FIGS. 3B and 3C are respectively the same type of three-dimensional representation for a road sign and for a rear vehicle light, 100 meters away from the vehicle equipped with the device. The maximum light intensity value achieved is similar in the two cases, so confusion is possible. However, it was found, in accordance with the invention, that the distribution corresponding to a road sign (FIG. 3B) contains many details, whereas that corresponding to a vehicle light (FIG. 3C) assumes an approximately Gaussian form.

In accordance with the invention, this “signature” is utilized in the manner illustrated in FIGS. 4A and 4B: when the sensor detects in an image a zone having overall a vehicle light/road sign-type distribution, the pixel cluster is cut two-dimensionally (FIG. 4A), passing through the centre of gravity thereof, the distribution of a theoretical curve Rt of Gaussian form having the same parameters (sigma, standard deviation, etc.) is calculated. A measurement of similarity is then carried out by calculating, for example, the mean square error of approximation of the real curve Rr relative to the theoretical curve Rt. It is then established whether or not the error level has reached a predetermined “similarity threshold” below which it is a road sign and above which it is a vehicle light.

The same type of calculation is carried out three-dimensionally (FIG. 4B); the real distribution and the distribution in Gaussian form are then compared three-dimensionally (theoretical distribution being shown, the real distribution being masked). Regardless of whether or not the error level reaches a “similarity threshold”, the results attained with the two-dimensional calculation will be corroborated or refuted. For example, the two-dimensional similarity threshold can be 96%, whereas the three-dimensional similarity threshold is generally chosen so as to be lower, for example 92%

The invention also allows identification/discrimination of light sources corresponding to remote vehicle lights (for example, more than 400 meters away). It is step C3, referred to hereinbefore and illustrated by FIGS. 6A and 6B, that resumes the same types of representation as in FIGS. 4A and 4B (representation of the variations in light intensity). The remote car lights appear on the images as two paired points having a characteristic form:

FIG. 6B is a three-dimensional representation thereof, showing two characteristic “bumps”, corresponding to the two vehicle lights,

FIG. 6A is a two-dimensional representation thereof.

A step according to the invention therefore consists in discerning the small paired spots, of low intensity, corresponding to remote vehicle lights, using the light intensity level signature thereof.

These calculations are repeated over a plurality of successively acquired images to check the correspondence of the results obtained before they may initiate switching of the projector from one lighting mode to another.

FIG. 5 now describes a complete algorithm of a high beam/dipped switching method according to the invention.

Although the embodiment described in the present case relates to a control for switching from a “high beam” mode to a “dipped” mode, there are obviously also appropriate strategies for automatically commanding a return from a “dipped” mode to a “high beam” mode, in particular taking into account the identification and the monitoring of the trajectories of the light sources and the presence or absence of bends on the road.

The algorithm comprises three portions delimited by dashed lines: the portion P1 which corresponds to preprocessing of the images (which may remain optional), the portion P2 which carries out more specifically the invention, and the portion P3 (which may remain optional like P1) which relates to an additional processing of the images described in detail hereinafter.

The algorithm breaks down as follows:

step A—of image acquisition by the sensor

preprocessing of the images P1 including

step I1 involving extraction of the contours of the zones from the images corresponding to light sources

step I2 involving the extraction of the vertical and horizontal segments from the zones

step I3 involving the construction of rectangular objects from the segments obtained in I2

step I4: elimination of the objects having a rectangular contour identified in I3, which saturate the sensor (corresponding to the highly reflective surfaces of posts at the edge of the road)

processing P2 of the images breaking down into:

thresholding step C0 for extracting the zones corresponding to projector lights

step C1 involving the extraction of the objects having a Gaussian form

step C2 involving the calculation of the parameters of the objects from step C1 (calculation of the similarity measurement)

step C3 involving the model search for the lights emitted by the vehicles far behind

Steps C1 and C3 are carried out simultaneously: if the zones corresponding to a light source within the image are too small within the image, the processing C3, rather than the processing of steps C1 and C2, is carried out.

spatial matching step L for identifying the pairs of vehicle lights: if two light sources are very close and similar to each other and they move at the same time, this step increases the degree of confidence in the identification of the sources carried out in step C2.

Further steps follow the processing P2:

step G for monitoring with respect to time, followed by a step H for identification of the trajectories: these two steps are linked insofar as the monitoring with respect to time provides a trajectory identification

step F for deciding to switch from the “high beam” mode to the “dipped” mode

The processing P3 provides, after the initial image acquisition step A, a step J for detecting the edges of the road (LDWS), the results of which allow the position of the horizon to be estimated during step K. Locating the horizon allows differentiation between a vehicle light/a motorcycle light and a road sign, for example, to be validated.

All the steps are repeated for any new image acquisition, thus allowing the detection of the already detected sources to be updated (providing a history of the positions of the source, the area of the zone corresponding to the source, etc.) before a command decision is taken in step F. (The sensor is capable of recording at least ten images per second.)

In conclusion, this type of processing allows a certain number of light sources to be easily discerned without utilizing a color sensor. Optional additional steps for preprocessing or processing the images further increase the reliability of the detection.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A method for controlling an automatic switching of a projector of a vehicle, in particular of a motor vehicle, from a first lighting mode to a second lighting mode, said method being implemented when said vehicle is driven at night and comprising the following steps:
acquisition by a black and white sensor of images representing night-time road scenes,
extraction from the image zones corresponding to light sources, and
discrimination of the type of light sources in accordance with the distribution of the levels of light intensity in said zones.

2. The method according to claim 1, wherein the discrimination step involving the discrimination of the type of light sources includes a zone-thresholding sub-step of said discrimination step allowing identification of the type A light sources saturating said black and white sensor with light intensity, including the passing vehicle projector lights.

3. The method according to claim 2, wherein said discrimination step involving the discrimination of the type of light sources includes a model-searching sub-step of said discrimination step for the lights emitted by vehicles far behind.

4. The method according to claim 2, wherein said discrimination step comprises:
determining the levels of light intensity in the non-thresholded zones and
measuring the similarity between the distribution of the levels of light intensity of each non-thresholded zone and a modeled distribution.

5. The method according to claim 4, wherein the modeled distribution is a Gaussian-type modeled distribution.

6. The method according to claim 5, wherein said discrimination step sorts the light zones depending on whether they are above or below a given level of similarity, the zones above said level corresponding to type B light sources including rear vehicle lights, the zones below said level corresponding to type C secondary light sources such as reflective road signs.

7. The method according to claim 1, comprising the step of:
controlling the switching of the projector from one lighting mode to another lighting mode taking account of the results of said discrimination step.

8. The method according to claim 7, wherein the acquisition, extraction and discrimination steps at least are repeated a plurality of times, and the results thereof compared before initiating, in the event of coincidence, switching-controlling step.

9. The method according to claim 2, comprising the step of:
controlling the switching of the projector from a high beam-type lighting mode to a dipped-type lighting mode in the event of the identification of type A light sources.

10. The method according to claim 6, comprising the step of:
controlling the switching of the projector from a high beam-type lighting mode to a dipped-type lighting mode in the event of the identification of type B light sources, or remaining in high beam mode in the event of the identification of type C light sources.

11. The method according to claim 1, wherein it also includes a step of monitoring with respect to time the displacements of the zones corresponding to light sources, followed by a step of identifying the trajectories of the zones corresponding to light sources.

12. The method according to claim 1, wherein it also includes an elimination step after the image acquisition step, said elimination step seeking to eliminate from the images the zones corresponding to secondary light sources of predetermined geometric shapes.

13. The method according to claim 12, wherein said elimination step
includes extraction of the contours of the zone corresponding to a light source within the image, extraction of the linear, in particular horizontal and vertical, segments of said zone, construction of geometrical objects from these segments, then elimination of said objects corresponding to predetermined geometric shapes, in particular rectangular shapes representing the reflective zones of signposts.

14. The method according to claim 1, wherein it includes a step
for detecting the lane edges LDWS, followed by a step for estimating the location of the horizon within the images acquired in said acquisition step.

15. A device for controlling the automatic switching of the projector of a vehicle, in particular of a motor vehicle, from a first lighting mode to a second lighting mode, said device being activated when said vehicle is driven at night, comprising:
means for the acquisition of images representing night-time road scenes, comprising a black and white sensor;
means for the extraction from the images of the zones corresponding to light sources; and
means for the discrimination of the type of light sources in accordance with the distribution of the levels of light intensity in said zones.

16. The device according to claim 15, comprises:
means for controlling the switching of the projectors from one lighting mode to another, taking account of the results obtained with the discrimination means.

17. The device according to claim 15, wherein said sensor is shared with at least one other device fitted to said vehicle.

18. An information storage means, wherein it stores one or more programs, the execution of which authorizes implementation of the method according to claim 1.

19. A computer program on an information storage means, comprising one or more sequences of instructions which can be executed by a microprocessor and/or a computer, the execution of said sequences of instructions authorizing implementation of the method according to claim 1.

20. A method for automatically switching a headlight from a first lighting mode to a second lighting mode, said method comprising the steps of:
sensing an image representing a night-time road scene with a black and white sensor;
extracting from said image at least one zone corresponding to a light source; and
identifying said light source in response to a distribution level of light intensity in said at least one zone;
automatically switching said headlight from said first lighting mode to said second lighting mode in response to said distribution level.

21. The method as recited in claim 20 wherein said method further comprises the step of:
allowing an identification of a type of light source based upon a saturation level of said black and white sensor.

22. The method as recited in claim 21 wherein said identifying step further comprises the steps of:
establishing zone-thresholding data associated with a passing vehicle projector light, vehicle tail lights or a sign;
using said zone-thresholding data to perform said identifying step.

23. An automatic headlight switching system comprising:
a headlight;
a control for controlling an operation of said headlight;
a black and white sensor for sensing an image representing a night-time road scene and generating image data in response thereto;
a processing unit coupled to said black and white sensor for receiving said image data and for extracting from said image at least one zone corresponding to a light source and also for identifying said light source in response to a distribution level of light intensity in said at least one zone; and
said control automatically switching said headlight from said first lighting mode to said second lighting mode in response to said distribution level.

24. The automatic headlight switching system as recited in claim 23 wherein said processing unit identifies said light source based upon a saturation level of said black and white sensor.

25. The automatic headlight switching system as recited in claim 23 wherein said light source is light from a passing vehicle projector light, from at least one vehicle tail light or from a sign.
